(19) United States
(12) Patent Application Publication
(10) Pub. No.: US 2008/0167054 A1
(43) Pub. Date: Jul. 10, 2008

(54) METHOD AND SYSTEM FOR PERFORMING CELL UPDATE AND ROUTING AREA UPDATE PROCEDURES WHILE A WIRELESS TRANSMIT/RECEIVE UNIT IS IN AN IDLE STATE

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/627,412

(22) Filed: Jan. 26, 2007

Related U.S. Application Data
(60) Provisional application No. 60/763,526, filed on Jan. 31, 2006.

(51) Int. Cl. H04Q 7/20

(52) U.S. Cl. 455/458

(57) ABSTRACT

A method and system for performing cell update and routing area (RA) update procedures while a wireless transmit/receive unit (WTRU) is in an idle state in a third generation (3G) long term evolution (LTE) wireless communication system. When the WTRU receives a page message or has data to transmit while the WTRU is in an idle state, the WTRU transitions to an active state and sends a cell update message to an evolved Node-B (eNode-B). The eNode-B forwards the cell update message to a mobility management entity (MME)/user plane entity (UPE). The MME/UPE changes the state of the WTRU to an active state and takes an action based on the cell update message. When the WTRU moves to a new RA, the WTRU sends an RA update message to the MME/UPE via the eNode-B. The MME/UPE updates the RA of the WTRU based on the RA update message.

### CROSS REFERENCE TO RELATED APPLICATION

This application claims the benefit of U.S. provisional application No. 60/763,526 filed Jan. 31, 2006, which is incorporated by reference as if fully set forth.

### FIELD OF INVENTION

The present invention is related to a third generation (3G) long term evolution (LTE) wireless communication system. More particularly, the present invention is related to a method and system for performing cell update and routing area (RA) update procedures while a wireless transmit/receive unit (WTRU) is in an idle state in an LTE wireless communication system.

### BACKGROUND

Developers of 3G wireless communication systems are considering 3G LTE systems. A 3G LTE wireless communication system provides an enhanced air interface to handle higher data rates with more efficiency, reduction of the number of signaling procedures and setup delay, and a network design to permit interconnection and interoperation of any air interface, such as global standards for mobile communication (GSM), general packet radio services (GPRS), wideband code division multiple access (WCDMA), CDMA2000, IEEE 802.xx, or the like.

FIG. 1 shows architecture for a 3G LTE wireless communication system 100. The LTE wireless communication system 100 includes an evolved Node-B (eNode-B) 110, an access gateway (aGW) 120 and a WTRU 130. The aGW 120 includes a mobility management entity (MME) 122 and a user plane entity (UPE) 124. Many of the functions of a radio network controller (RNC) in the conventional 3G system have been moved to the eNode-B 110.

The MME 122 manages and stores WTRU context, (e.g., WTRU and user identities, WTRU mobility state, user security parameters, or the like). The MME 122 generates temporary identities for the WTRU 130 and allocates them to the WTRU 130. The MME 122 authenticates the user of the WTRU 130 and checks the authorization whether the WTRU 130 may camp on a certain tracking area (TA) or on a certain public land mobile network (PLMN). The MME 122 supports the mobility operation between different eNode-Bs 110 and maintains the seamless service continuity for the WTRU 130.

The UPE 124 terminates both downlink and uplink data paths for an LTE_Idle state of the WTRU 130, and triggers and initiates paging when downlink data arrives for the WTRU 130. The UPE 124 manages and stores WTRU contexts, (e.g., parameters of an Internet protocol (IP) bearer service and network internal routing information).

Both the MME 122 and the WTRU 130 maintain an LTE state machine for mobility management as shown in FIG. 2. The state of the WTRU 130 may be one of an LTE_Detached state, an LTE_Idle state and an LTE_Active state. In an LTE_Detached state, the WTRU 130 is powered off and there is no RRC entity. At this state, the position of the WTRU 130 is not known to the system 100. Upon power-up, the WTRU 130 makes a state transition from an LTE_Detached state to an LTE_Active state, and performs registration with the system 100.

During the transition from the LTE_Detached state to the LTE_Active state, the WTRU 130 establishes a mobility management (MM) state and obtains a packet data protocol (PDP) context. The WTRU 130 also obtains a security context, a radio resource control (RRC) context, a capability context, a quality of service (QoS) context, a radio bearer (RB) context, and temporary identities. A cell radio network temporary identity (C-RNTI), a tracking area identity (TA-ID), an IP address, or the like are allocated to the WTRU 130 and authentication and a security relation are established. At this point, the location of the WTRU 130 is known to the system 100 at a cell level.

After registration, the WTRU 130 may be forced to transition to the LTE_Idle state from the LTE_Active state by the system 100 due to inactivity or other reason. The WTRU 130 may transition to the LTE_Idle state by itself. While the WTRU 130 is in the LTE_Idle state, the WTRU 130 is assigned a tracking area (TA) and the location of the WTRU 130 is known to the network at a TA level.

FIG. 3 shows exemplary LTE routing areas (RAs). An LTE_Idle state function is handled by the MME and/or the UPE. It should be noted that FIG. 3 shows three RAs as an example and any number and any levels of RAs may exist and any number of cells may be included in one RA. In FIG. 3, cells 1 and 2 are included in an LTE RA 1, cells 2-4 are includes in an LTE RA 2, and cells 4-6 are included in an LTE RA3. The cells are partially overlapped between adjacent RAs in order to avoid a ping-pong.

While the WTRU 130 is in an LTE_Idle state, the WTRU 130 is required to make a fast transition to the LTE_Active state, (e.g., below 100 ms), when the transition is needed, (e.g., when the WTRU 130 receives a paging message). In addition, unnecessary traffic during the LTE_Idle state should be eliminated.

Therefore, it would be desirable to provide a method and system for fast cell update and RA update while a WTRU 130 is in an LTE_Idle state.

### SUMMARY

The present invention is related to a method and system for performing cell update and RA update procedures while a WTRU is in an idle state in a 3G LTE wireless communication system. When the WTRU receives a page message or has data to transmit while the WTRU is in an idle state, the WTRU transitions to an active state and sends a cell update message to an eNode-B. The eNode-B forwards the cell update message to an MME/UPE. The MME/UPE changes the state of the WTRU to an active state and takes an action based on the cell update message. When the WTRU is in an idle state and moves to a new RA, the WTRU sends an RA update message to the MME/UPE via the eNode-B. The MME/UPE updates the RA for the WTRU based on the RA update message.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a network architecture proposed for 3G LTE wireless communication system;

FIG. 2 shows an LTE state machine;

FIG. 3 shows exemplary LTE RAs;

FIG. 4 is a signal flow diagram of a process for performing an LTE cell update in accordance with the present invention;

FIG. 5 is a signal flow diagram of a process for performing an LTE cell update in accordance with another embodiment of the present invention; and

FIG. 6 is a signal flow diagram of a process for performing an LTE RA update in accordance with the present invention.

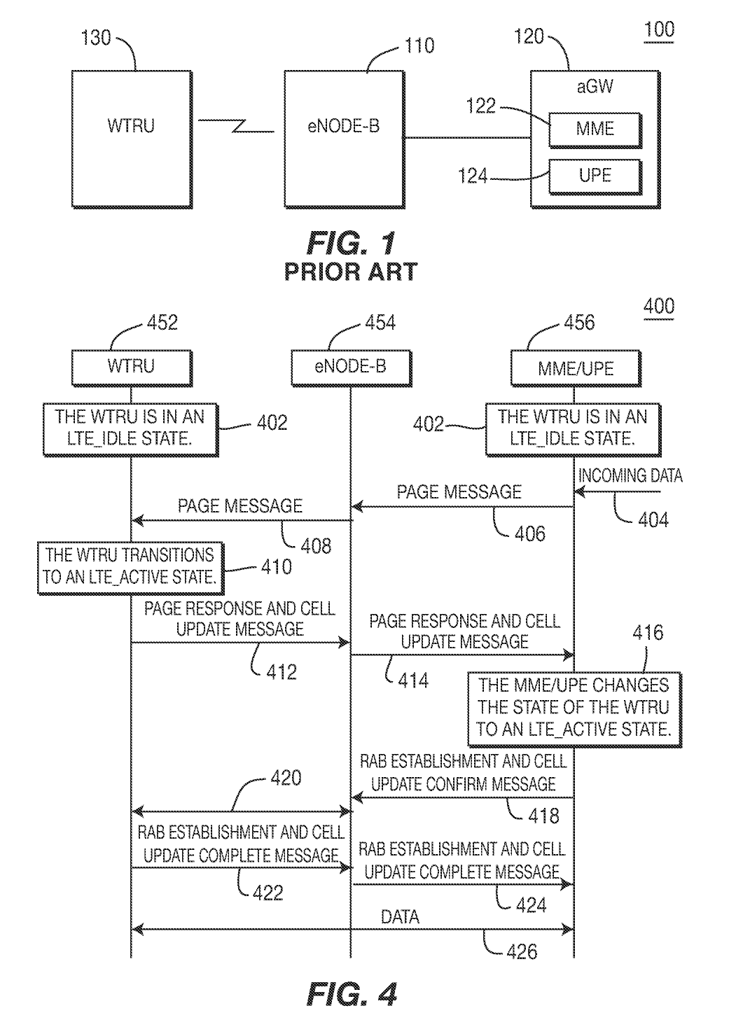

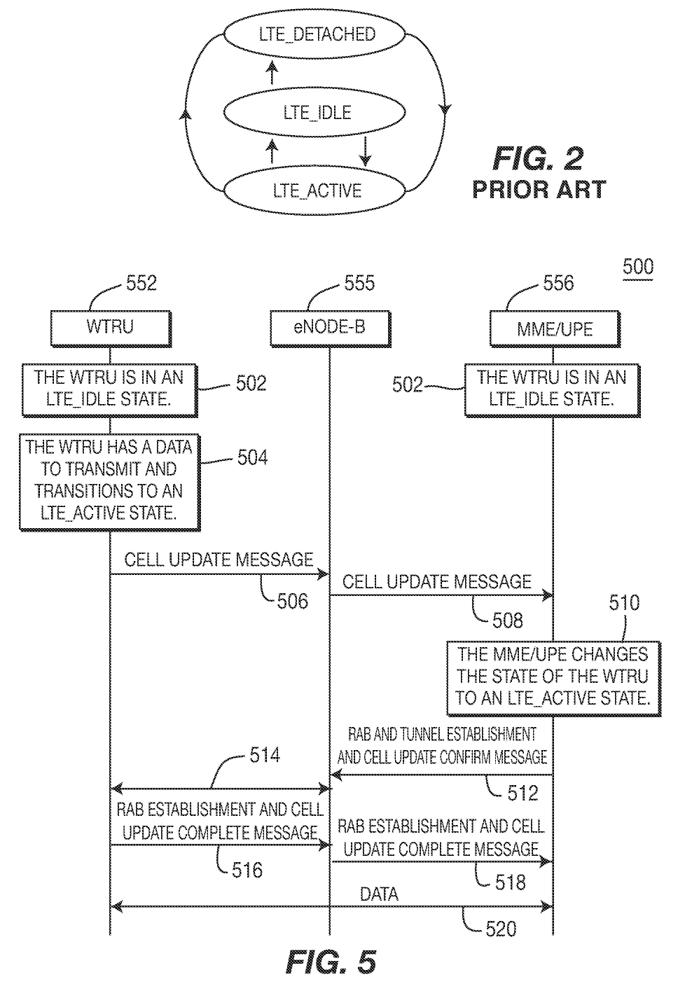

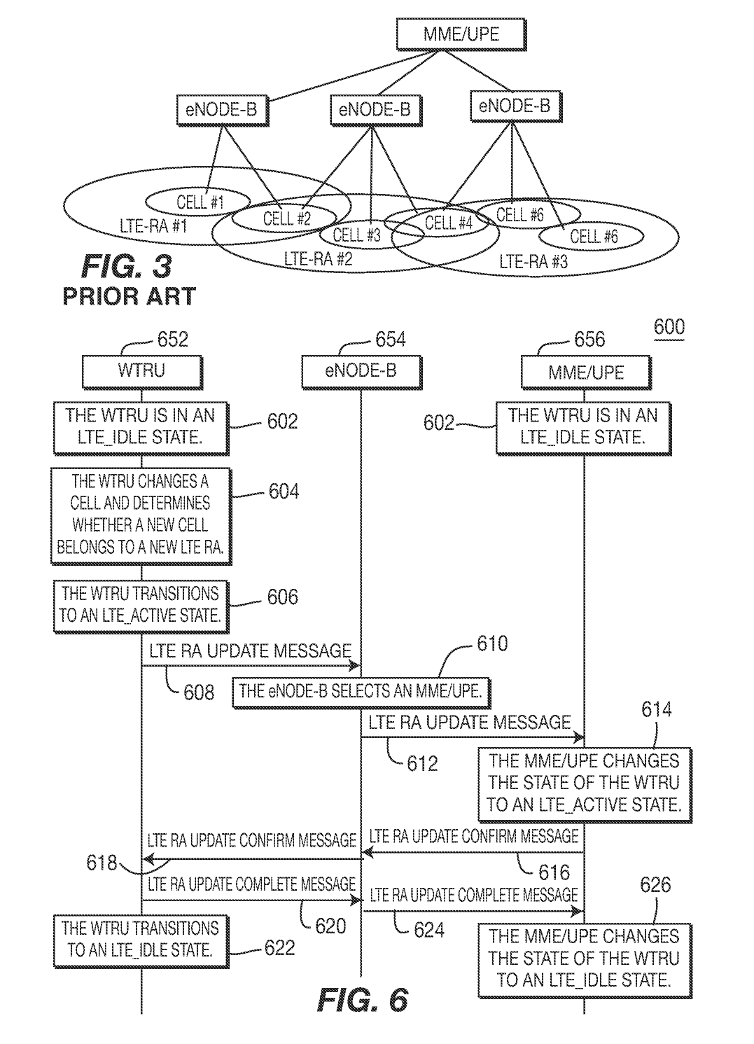

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “eNode-B” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

FIG. 4 is a signal flow diagram of a process 400 for performing an LTE cell update procedure in accordance with the present invention. A WTRU 452 is currently in an LTE_Idle state, and the state of the WTRU is also set to an LTE_Idle state in an MME/UPE 456 (step 402). In an LTE_Idle state, the WTRU 452 operates in a discontinuous reception (DRX) mode camping on a paging channel. While the WTRU 452 is in an LTE_Idle state, an LTE cell update is performed autonomously.

Upon receipt of incoming traffic for the WTRU 452 at step 404, the MME/UPE 456 pages the WTRU 452 in an LTE RA for the WTRU 452. The MME/UPE 456 sends a page message to an eNode-B 454 (step 406). The eNode-B 454 transmits the page message to the WTRU 452 (step 408). Upon receipt of the page message, the WTRU 452 transitions from the LTE_Idle state to an LTE_Active state (step 410).

The WTRU 452 then sends a cell update message along with a page response message to the eNode-B 454 (step 412). The cell update message includes a temporary identity, (e.g., radio network temporary identity (RNTI)), of the WTRU 452 assigned by the MME/UPE 456. The eNode-B 454 forwards the cell update message to a proper MME/UPE 456 based on the identity, (e.g., RNTI), (step 414). This makes it possible to support a multi-to-multi configuration between eNode-Bs and MME/UPEs. Multi-to-multi configuration refers to different deployment scenarios for MME/UPE, including a combination of the MME and the UPE in a single device and variations of separate MME and UPE, (e.g., a stand-alone MME/UPE separate from the aGW and a stand-alone MME with UPE included in the aGW where a single UPE supports multiple MMEs).

After receiving the cell update message, the MME/UPE 456 changes the state of the WTRU 452 to an LTE_Active state (step 416) and sends a radio access bearer (RAB) establishment and cell update confirmation message to the eNode-B 454 (step 418). An RAB is then established between the eNode-B 454 and the WTRU 452 based on the RAB establishment message (step 420). The WTRU 452 then sends an RAB establishment and cell update complete message to the eNode-B 454 (step 422). The eNode-B 454 forwards the RAB establishment and cell update complete message to the MME/UPE 456 (step 424). User data is then communicated between the WTRU 452 and the MME/UPE 456 (step 426).

The LTE cell update procedure may also be performed when the WTRU has pending traffic data to transmit, (i.e., data or signaling). FIG. 5 is a signal flow diagram of a process 500 for performing an LTE cell update procedure in order to establish a proper RAB and an associated tunnel for the pending traffic in accordance with another embodiment of the present invention. A WTRU 552 is currently in an LTE_Idle state without an RAB or tunnel established, and the state of the WTRU 552 is also set to an LTE-Idle state in an MME/UPE 556 (step 502).

When the WTRU 552 has data to transmit, the WTRU 552 transitions from the LTE_Idle state to an LTE_Active state (step 504). The WTRU 552 then sends a cell update message to the eNode-B 554 (step 506). The LTE cell update message includes information regarding the last RA update, (e.g., last RA identification or last cell update ID), along with a temporary identification, (e.g., RNTI), of the WTRU 552 assigned by the last serving MME/UPE 556. The eNode-B 554 analyzes the last RA or cell update information to determine a proper serving MME/UPE, and then forwards the LTE cell update message to the proper MME/UPE 556 based on the identity, (e.g., RA ID, cell update ID, or RNTI), (step 508).

After receiving the cell update message, assuming the same serving MME/UPE, (i.e., the same MME/UPE supported the eNode-B from which the WTRU's last communication), the MME/UPE 556 changes the state of the WTRU 552 to an LTE_Active state (step 510) and sends an RAB and tunnel establishment and cell update confirmation message back to the eNode-B 554 (step 512). A new tunnel is then established between the UPE 556 and the eNode-B 554. A new RAB is also established between the eNode-B 554 and the WTRU 552 based on the RAB establishment message (step 514). After an RAB is established between the WTRU 552 and the eNode-B 554, the WTRU 552 sends an RAB establishment and cell update complete message to the eNode-B 554 (step 516). The eNode-B 554 forwards the RAB establishment and cell update complete message to the MME/UPE 556 (step 518). User data is then communicated between the WTRU 552 and the MME/UPE 556 (step 520).

FIG. 6 is a signal flow diagram of a process 600 for performing an LTE RA update in accordance with the present invention. A WTRU 652 is currently in an LTE_Idle state, and the state of the WTRU is also set to an LTE_Idle state in an MME/UPE 656 (step 602). In an LTE_Idle state, the WTRU 652 operates in a discontinuous reception (DRX) mode camping on a paging channel. When the WTRU 652 changes a cell, the WTRU 652 camps on a broadcast control channel (BCCH) in a new cell to receive a cell identity of the new cell and determines whether the new cell belongs to a new LTE RA (step 604). If it is determined that the new cell belongs to a new LTE RA, the WTRU 652 performs a RA update procedure. The LTE RA update may be performed periodically. In this operation there is no need for RAB establishment between the WTRU 652 and the eNode-B 654, or tunnel establishment between the eNode-B 654 and the UPE 656 since there is no data traffic to transmit.

The WTRU 652 transitions from an LTE_Idle state to an LTE_Active state (step 606). The WTRU 652 then sends an LTE RA update message to the eNode-B 654 (step 608). The LTE RA update message includes a temporary identity of the WTRU 652, (e.g., RNTI). The eNode-B 654 selects a proper MME/UPE 656 based on the temporary identity of the WTRU 652 (step 610) and routes the LTE RA update message to the selected MME/UPE 656 (step 612).

Upon receipt of the LTE RA update message, the MME/UPE 656 changes the state of the WTRU 652 to an LTE_Active state (step 614). The state of the WTRU 652 is changed because the WTRU 652 is known at the cell level at this moment and there is no need to page the WTRU 652 over the RA when new data traffic for the WTRU 652 arrives. The MME/UPE 656 then sends an LTE RA update confirm message to the eNode-B 654 (step 616). The LTE RA update confirm message includes a new LTE RA for the WTRU 652 and may also include an order to change the state of the WTRU 652 back to the LTE_Idle state. The eNode-B 654 forwards the LTE RA update confirm message to the WTRU (step 618).

After receiving the LTE RA update confirm message, the WTRU 652 sends an LTE RA update complete message to the eNode-B 654 (step 620) and transitions to an LTE_Idle state (step 622). The eNode-B 654 forwards the LTE RA update complete message to the MME/UPE 656 (step 624). The MME/UPE 656 then changes the state of the WTRU 652 to an LTE_Idle state (step 626).

The cell update and/or the RA update may be performed periodically. The cell update may also be performed in the case of a radio link control (RLC) unrecoverable error, upon a radio link failure, reentering service area, cell reselection, or the like.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a wireless transmit/receive unit (WTRU), an evolved Node-B (eNode-B) and a mobility management entity (MME)/user plane entity (UPE), a method of performing a cell update procedure while the WTRU is in an idle state, the method comprising:
the WTRU transitioning from an idle state to an active state;
the WTRU sending a cell update message to the eNode-B;
the eNode-B forwarding the cell update message to the MME/UPE; and
the MME/UPE changing a state machine for the WTRU in the MME/UPE to an active state and taking an action based on the cell update message.

2. The method of claim 1 further comprising:
the WTRU receiving a page message while in the idle state, wherein the WTRU sends the cell update message along with a page response message in response to the page message.

3. The method of claim 1 wherein the cell update message includes a radio network temporary identity (RNTI) of the WTRU and the eNode-B selects an MME/UPE among a plurality of MMEs/UPEs based on the RNTI.

4. The method of claim 1 wherein the WTRU sends the cell update message when the WTRU has data to transmit.

5. The method of claim 1 further comprising:
the MME/UPE sending a cell update confirm message and a radio access bearer (RAB) establishment message to the WTRU via the eNode-B;
the eNode-B and the WTRU establishing an RAB based on the RAB establishment message;
the WTRU sending an RAB establishment and cell update complete message to the MME/UPE via the eNode-B; and
the MME/UPE and the WTRU communicating user data.

6. The method of claim 1 wherein the WTRU sends the cell update message periodically.

7. The method of claim 1 wherein the WTRU sends the cell update message when one of a radio link control (RLC) unrecoverable error, a radio link failure, reentering service area and cell reselection occurs.

8. The method of claim 1 wherein the wireless communication system is a third generation (3G) long term evolution (LTE) wireless communication system.

9. In a wireless communication system including a wireless transmit/receive unit (WTRU), an evolved Node-B (eNode-B) and a mobility management entity (MME)/user plane entity (UPE), a method of performing a routing area (RA) update procedure while the WTRU is in an idle state, the method comprising:
the WTRU in an idle state reading system information transmitted by the eNode-B;
the WTRU transitioning from an idle state to an active state if it is determined that the WTRU is in a new RA based on the system information;
the WTRU sending an RA update message to the eNode-B;
the eNode-B forwarding the RA update message to the MME/UPE; and
the MME/UPE updating the RA for the WTRU based on the RA update message.

10. The method of claim 9 wherein the RA update message includes a radio network temporary identity (RNTI) of the WTRU and the eNode-B selects an MME/UPE among a plurality of MMEs/UPEs based on the RNTI.

11. The method of claim 9 wherein the WTRU receives the system information via a broadcast control channel (BCCH).

12. The method of claim 9 further comprising:
the MME/UPE sending an RA update confirm message to the WTRU via the eNode-B; and
the WTRU sending an RA update complete message to the MME/UPE via the eNode-B.

13. The method of claim 12 further comprising:
the WTRU transitioning to an idle state after sending the RA update complete message; and
the MME/UPE changing a state machine for the WTRU in the MME/UPE to an idle state.

14. The method of claim 9 wherein the WTRU sends the RA update message periodically.

15. The method of claim 9 wherein the wireless communication system is a third generation (3G) long term evolution (LTE) wireless communication system.

16. A wireless communication system configured to perform a cell update procedure while a wireless transmit/receive unit (WTRU) is in an idle state, the system comprising:
a WTRU configured to transition from an idle state to an active state and send a cell update message to an evolved Node-B (eNode-B);
the eNode-B configured to forward the cell update message to a mobility management entity (MME)/user plane entity (UPE); and
the MME/UPE configured to change a state machine for the WTRU in the MME/UPE to an active state and take an action based on the cell update message.

17. The system of claim 16 wherein the WTRU is configured to receive a page message while in the idle state and send the cell update message along with a page response message in response to the page message.

18. The system of claim 16 wherein the cell update message includes a radio network temporary identity (RNTI) of the WTRU and the eNode-B is configured to select an MME/UPE among a plurality of MMEs/UPEs based on the RNTI.

19. The system of claim 16 wherein the WTRU is configured to send the cell update message when the WTRU has data to transmit.

20. The system of claim 16 wherein the MME/UPE is configured to send a cell update confirm message and a radio access bearer (RAB) establishment message to the WTRU via the eNode-B and communicate user data with the WTRU after receiving an RAB establishment and cell update complete message from the WTRU, and the WTRU is configured to send the RAB establishment and cell update complete message to the MME/UPE after establishing an RAB with the eNode-B and communicate the user data with the MME/UPE.

21. The system of claim 16 wherein the WTRU is configured to send the cell update message periodically.

22. The system of claim 16 wherein the WTRU is configured to send the cell update message when one of a radio link control (RLC) unrecoverable error, a radio link failure, reentering service area and cell reselection occurs.

23. The system of claim 16 wherein the wireless communication system is a third generation (3G) long term evolution (LTE) wireless communication system.

24. A wireless communication system configured to perform a routing area (RA) update procedure while a wireless transmit/receive unit (WTRU) is in an idle state, the system comprising:
a WTRU configured to read system information transmitted by an evolved Node-B (eNode-B) while the WTRU is in an idle state, transition from an idle state to an active state if it is determined that the WTRU is in a new RA based on the system information, and send an RA update message to the eNode-B;
the eNode-B configured to forward the RA update message to a mobility management entity (MME)/user plane entity (UPE); and
the MME/UPE configured to update an RA for the WTRU based on the RA update message.

25. The system of claim 24 wherein the RA update message includes a radio network temporary identity (RNTI) of the WTRU and the eNode-B is configured to select an MME/UPE among a plurality of MMEs/UPEs based on the RNTI.

26. The system of claim 24 wherein the WTRU receives the system information via a broadcast control channel (BCCH).

27. The system of claim 24 wherein the MME/UPE is configured to send an RA update confirm message to the WTRU via the eNode-B and the WTRU is configured to send an RA update complete message to the MME/UPE via the eNode-B.

28. The system of claim 27 wherein the WTRU is configured to transition to an idle state after sending the RA update complete message and the MME/UPE is configured to change a state machine for the WTRU in the MME/UPE to an idle state after receiving the RA update complete message.

29. The system of claim 24 wherein the WTRU is configured to send the RA update message periodically.

30. The system of claim 24 wherein the wireless communication system is a third generation (3G) long term evolution (LTE) wireless communication system.
